(19) United States
(12) Patent Application Publication
(10) Pub. No.: US 2005/0210225 A1
(43) Pub. Date: Sep. 22, 2005

(54) Hybrid branch prediction

(75) Inventor: Michael W. Morrow, Chandler, AZ (US)

Correspondence Address: LeMoine Patent Services, PLLC;c/o PortfolioIP, P.O. Box 52050, Minneapolis, MN, 55402, US

(73) Assignee: Intel Corporation

(21) Appl. No.: 10/805,947

(22) Filed: Mar. 22, 2004

(51) Int. Cl. G06F 9/00

(52) U.S. Cl. 712/239

(57) ABSTRACT

A hybrid branch predictor capable of performing static and dynamic branch prediction operates in a single pipeline stage.

### FIELD

The present invention relates generally to processors, and more specifically to processors with branch prediction.

### BACKGROUND

Pipelined processors may experience a degradation in performance when a program “branches,” in part because a portion of the pipeline may go underutilized. A processor may predict the outcome of a branch in an effort to reduce the performance penalty associated with branches.

### BRIEF DESCRIPTION OF THE DRAWINGS

FIG. 1 shows a diagram of a processor;

FIG. 2 shows a diagram of a hybrid branch predictor;

FIG. 3 shows a table representation of a dynamic branch predictor;

FIG. 4 shows a flowchart in accordance with various embodiments of the present invention; and

FIG. 5 shows a system diagram in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

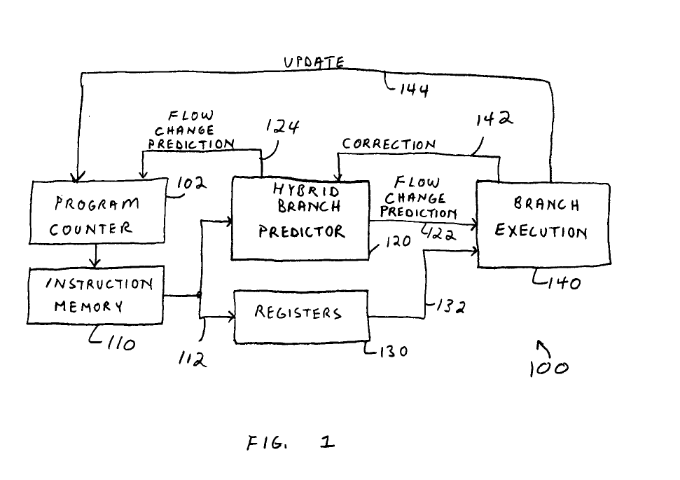

FIG. 1 shows a diagram of a processor. Processor 100 includes program counter (PC) 102, instruction memory 110, hybrid branch predictor 120, registers 130, and branch execution unit 140. Processor 100 may also include many other components. For example, processor 100 may include address generation hardware, one or more arithmetic logic units (ALUs), or the like. Also for example, processor 100 may include components to further support pipelining and instruction level parallelism (ILP). In general, processor 100 may include any hardware or software that may be useful for a processor. For simplicity and clarity, processor 100 is shown in FIG. 1 with less than all possible components. The various embodiments of the present invention are not meant to be limited in this respect.

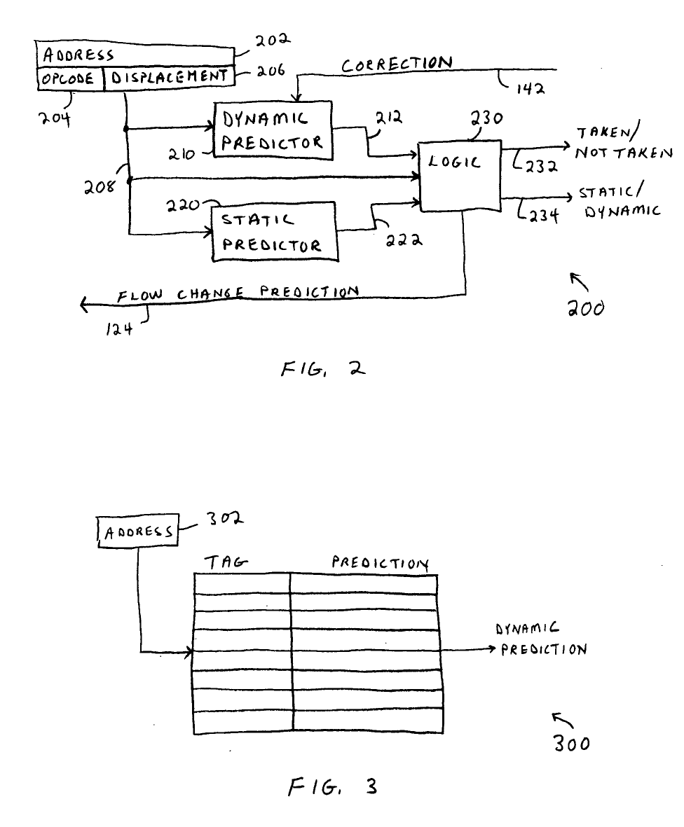

Processor 100 executes instructions to perform useful work. Processor 100 may execute the instructions in a linear manner, in a parallel manner, or any combination. Processor instructions may be in the form of “machine instructions” that include operand codes (opcodes) and other fields, and may be of many different types. For example, an instruction may provide information for arithmetic operations, logical operations, or program flow change operations. A branch instruction (referred to herein as a “branch”) is an example of an instruction that may perform a program flow change operation. Examples of branch instructions are described below with reference to FIG. 2.

Processor 100 is an example of a pipelined processor. Any number of pipeline stages may exist, but for simplicity, three stages are shown in FIG. 1. Instruction memory 110 operates in an instruction fetch (IF) stage, hybrid branch predictor 120 and registers 130 operate in an instruction decode (ID) stage, and branch execution unit 140 operates in an execution (EX) stage. If a branch causes a change in control flow, one or more pipeline stages may need to be “flushed,” in order to “fill” the pipeline with instructions starting at the target address of the branch. The various blocks shown in FIG. 1, including hybrid branch predictor 120, operate to reduce the overhead associated with branches and control flow changes.

Program counter 102 provides an address to instruction memory 110. When a program executes in a linear manner, program counter 102 may increment such that instructions are fetched from instruction memory 110 in a linear manner. When a program branches, program counter 102 may be loaded with a branch target address to effect instruction fetches beginning at the appropriate instruction in the program flow. In some embodiments, program counter 102 may also be referred to as an instruction pointer (IP).

Instruction memory 110 holds instructions to be executed by processor 100. For example, instruction memory 110 may be a cache memory or a register file that holds software instructions. As shown in FIG. 1, instructions are provided on node 112 to hybrid branch predictor 120 and registers 130. In some embodiments, instruction memory 110 provides instructions, directly or indirectly, to many other functional blocks within processor 100. For example, instruction memory 110 may provide instructions directly to other functional blocks on node 112, and registers 130 may provide instructions indirectly to other functional blocks on node 132.

In some embodiments, instruction memory 110 is not included within processor 100, but rather, is external to processor 100. For example, some processor embodiments do not include cache memory or other addressable program memory, and program counter 102 either drives external address lines directly or is used to derive an address that is driven on address lines external to processor 100.

Branch execution unit 140 receives information from hybrid branch predictor 120, registers 130, and other sources within processor 100, and resolves whether or not a particular branch should be taken. Branch execution unit 140 resides in a later pipeline change and is able to resolve with certainty whether the branch should be taken. For example, the branch may be conditionally taken based on the outcome of a logical comparison between two values that may not be loaded and ready prior to the pipeline stage in which branch execution unit 140 operates. Also for example, a branch may be conditionally taken based on the evaluation of an arithmetic expression, and the operands of the expression may not be loaded and ready prior to the pipeline stage in which branch execution unit 140 operates.

Because branch execution unit 140 resolves branches in a later stage of the pipeline, a branch prediction mechanism may be placed in the pipeline prior to branch execution unit 140 to predict whether branches are taken or not taken and to possibly reduce the overhead associated with a mispredicted branch. Hybrid branch predictor 120, discussed below, represents various embodiments of branch prediction mechanisms.

Hybrid branch predictor 120 predicts if a branch instruction will cause a change in program control flow. For example, hybrid branch predictor 120 may receive a branch instruction on node 112, and provide a flow change prediction to program counter 102 on node 124, and also provide a flow change prediction to branch execution unit 140 on node 122.

In some embodiments, hybrid branch predictor 120 includes a combination of a static predictor and a dynamic predictor. The static predictor may make a prediction that is not related to previous execution history, and the dynamic predictor may override the static predictor based on previous execution history, if any. In some embodiments, hybrid branch predictor 120 includes a dynamic predictor that may be updated. For example, branch execution unit 140 may provide a correction to hybrid branch predictor 120 using node 142 when hybrid branch predictor 120 has performed an incorrect prediction (“mispredicted”). Example branch predictor embodiments, including updatable dynamic predictors, are described more fully below.

The flow change prediction on node 124 may include a new address from which to fetch an instruction, or may include an offset value to indicate an offset from the current program counter value. Further, the flow change prediction on node 124 may include one or more control signals to indicate whether a branch should be predicted as taken or not taken. The present invention is not limited by the manner in which program counter 102 is updated when a branch is either predicted or taken.

The flow change prediction on node 122 may include an indication whether the branch was predicted taken or predicted not taken, and may also include an indication of the type of prediction made. For example, the flow change prediction on node 122 may include information describing whether the prediction was made by a static predictor, a dynamic predictor, or a combination static/dynamic predictor.

As previously described, branch execution unit 140 resolves whether a branch is taken or not taken. Branch execution unit 140 may also determine whether a particular branch was mispredicted. For example, if hybrid branch predictor 120 predicts a branch is not taken, and branch execution unit 140 determines that the branch is taken, then a misprediction has occurred.

In some embodiments, branch execution unit 140 may provide a correction to hybrid branch predictor 120 on node 142. For example, if hybrid branch predictor 120 mispredicts a branch, a dynamic branch predictor within hybrid branch predictor 120 may be updated in an attempt to improve branch prediction the next time the same branch instruction is encountered.

In some embodiments, hybrid branch predictor 120 is updated only when a misprediction is a result of a static prediction. In other embodiments, hybrid branch predictor 120 is updated when a misprediction has occurred regardless of the type of predictor utilized. For example, hybrid branch predictor 120 may provide information describing the type of predictor utilized along with the flow change prediction on node 122. In response thereto, and also in response to a misprediction, branch execution unit 140 may or may not provide a correction on node 142.

FIG. 2 shows a diagram of a hybrid branch predictor. Hybrid branch predictor 200 may be used as a hybrid branch predictor in a processor such as hybrid branch predictor 120 (FIG. 1). Hybrid branch predictor 200 includes dynamic predictor 210, static predictor 220, and logic 230. In operation, hybrid branch predictor 200 receives at least part of a processor instruction and an instruction address. The instruction may or may not be a branch instruction; however, for the purposes of explaining hybrid branch predictor 200, the instruction is assumed to be a branch instruction. The instruction address is shown at 202, and the branch instruction includes opcode 204 and displacement field 206. Static predictor 220 provides a static branch prediction based on the address and/or the instruction, and dynamic predictor 210 may provide a prediction based on state information that is updateable based, at least in part, on past predictions or mispredictions.

In some embodiments, static predictor 220 receives the instruction on node 208 and performs a branch prediction based on the contents of the instruction. For example, in some embodiments, static predictor 220 may perform a prediction based on the direction of the branch. In some embodiments, static predictor 220 may predict the branch taken if the displacement field signifies a branch backward. In other embodiments, static predictor 220 may predict the branch taken if the displacement field signifies a branch forward. In some embodiments, static predictor 220 may predict a branch taken or not taken based on a particular opcode. For example, static predictor 220 may predict a branch taken if it is a “branch if equal” opcode, and in other embodiments, static predictor 220 may predict a branch taken if it is a “branch if not equal” opcode. Any static criteria may be utilized by static predictor 220 without departing from the scope of the present invention. Static predictor 220 provides a branch prediction to logic 230 on node 222.

Dynamic predictor 210 may or may not provide a branch prediction for a particular branch instruction. For example, in some embodiments, dynamic predictor 210 maintains a branch prediction buffer that includes entries for particular branch instructions. The branch prediction buffer may or may not include an entry for a particular branch instruction. If an entry exists, then a dynamic prediction will be provided on node 212, and if an entry does not exist, then a dynamic prediction will not be provided on node 212.

Dynamic branch predictions, if provided, may override static predictions. For example, if static predictor 220 predicts a branch taken and dynamic predictor 210 predicts the branch not taken, then logic 230 may provide a prediction of not taken on node 232. On the other hand, if static predictor 220 predicts a branch taken and dynamic predictor 210 does not provide a prediction, then logic 230 may pass the static prediction of taken to node 232.

In some embodiments, logic 230 receives a static prediction from static predictor 220, a dynamic prediction from dynamic predictor 210, and instruction information on node 208. Logic 230 may provide a prediction of taken or not taken on node 232 and in some embodiments, may also provide an indication of whether the prediction is a result of a static or dynamic prediction on node 234. Further, in some embodiments, logic 230 may provide a flow change prediction on node 124. The flow change prediction may include an instruction address to load into a program counter, or may include the contents of displacement field 206. In some embodiments, the flow change prediction may include a value derived from the contents of displacement field 206. The manner in which a flow change prediction is provided is not a limitation of the present invention.

Dynamic predictor 210 may be updated if a correction is received on node 142. For example, if hybrid branch predictor 200 performs a misprediction, a branch execution unit in a later pipeline stage may detect the misprediction and provide a correction on node 142. Further, the branch execution unit may provide a correction based on multiple factors. For example, as shown in FIG. 2, hybrid branch predictor 200 may provide a prediction on node 232 as well as an indication of the source of the prediction (static/dynamic) on node 234. Referring now to FIG. 1, branch execution unit 140 may receive both the prediction and the source indication on node 122, and may conditionally provide correction based on this information. In some embodiments, a branch execution unit may only provide a correction when a static prediction results in a misprediction, and in other embodiments, a branch execution unit may provide a correction when a static prediction results in a misprediction or the source of a prediction is a dynamic prediction. In still further embodiments, a correction may be provided regardless of whether a misprediction occurred, and regardless of the source of the prediction. A branch execution unit may use any combination of various criteria to cause an update of a dynamic predictor.

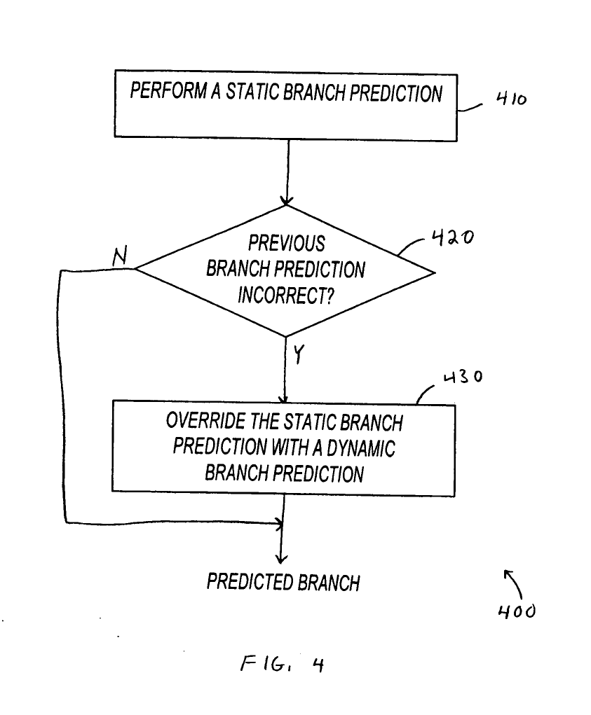

FIG. 3 shows a table representation of a dynamic branch predictor. Table 300 shows information that may be stored in a branch prediction buffer within a dynamic predictor such as dynamic predictor 210. The actual table may be stored in a memory, a register file, or any other suitable storage device. Further, a dynamic predictor that holds the information shown in FIG. 3 may also include control circuitry for addressing the table, performing comparisons with data in the table, updating the table, or the like. The various embodiments of the present invention are not limited by any particular implementation of a hybrid predictor.

Table 300 includes a number of entries arranged in rows, where each entry includes a tag field and a prediction field. In some embodiments, entries in table 300 may be “aliased” in such a way that an entry may have a high probability of being associated with a particular branch instruction in a program. In other embodiments, a particular entry in table 300 may be uniquely identified in such a way that it can be associated with one and only one branch instruction in a program.

Address field 302 corresponds to all or part of the instruction address 202 (FIG. 2). In some embodiments, a portion of address field 302 may be used to address an entry in table 300, and another portion of the address field may be used to match a tag in the tag field of the addressed entry. In embodiments where address field 302 includes the entire contents of instruction address 202 (FIG. 2), a corresponding entry in table 300 may be uniquely identified, and in embodiments where address field 302 includes less than all of instruction address 202, aliasing may occur.

The prediction field of table 300 may include any type of dynamic prediction information. For example, in some embodiments, a single bit predictor is utilized that signifies whether the last branch was taken or not taken. In other embodiments, a two or more bit predictor is utilized to provide hysteresis in the dynamic branch prediction. For example, a two bit predictor may operate as a state machine that cycles through four states like a counter that counts up when a branch is taken, and counts down when a branch is not taken. The various embodiments of the present invention are not limited by the particular implementation for the dynamic branch prediction.

A branch instruction may or may not have an entry in table 300. For example, in some embodiments, a branch instruction that has never been mispredicted by a static predictor will not have an entry in table 300. When this branch is encountered in the program, the dynamic predictor will not provide a prediction. Also in these embodiments, if a misprediction occurs, then a correction for the branch will be provided after a branch execution unit has resolved the branch, and an entry will be made. Each time thereafter that the branch is encountered, the dynamic predictor will provide a dynamic prediction based on the prediction field of the entry associated with the branch. If the table is full, and a new branch instruction is mispredicted, an entry may be replaced. Any algorithm, including a least recently used (LRU) algorithm may be employed to determine the entry to be replaced.

Table 300 is shown with room for eight entries. In some embodiments, more than eight entries are possible, and in other embodiments, less than eight entries are possible. Combining a static predictor with a relatively small dynamic predictor in the same pipeline stage may increase branch prediction accuracy without a large area or power penalty.

Processors, hybrid branch predictors, dynamic branch predictors, branch prediction update mechanisms, and other embodiments of the present invention can be implemented in many ways. In some embodiments, they are implemented in integrated circuits. In some embodiments, design descriptions of the various embodiments of the present invention are included in libraries that enable designers to include them in custom or semi-custom designs. For example, any of the disclosed embodiments can be implemented in a synthesizable hardware design language, such as VHDL or Verilog, and distributed to designers for inclusion in standard cell designs, gate arrays, or the like. Likewise, any embodiment of the present invention can also be represented as a hard macro targeted to a specific manufacturing process. For example, hybrid branch predictor 200 (FIG. 2) may be represented as polygons assigned to layers of an integrated circuit.

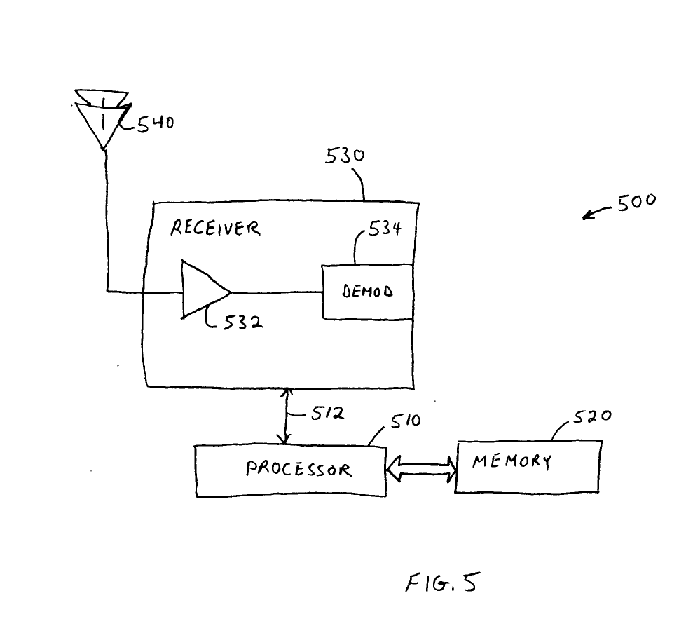

FIG. 4 shows a flowchart in accordance with various embodiments of the present invention. In some embodiments, method 400, or portions thereof, is performed by a processor, embodiments of which are shown in the various figures. In other embodiments, method 400 is performed by a hybrid branch predictor, a processor pipeline, an integrated circuit, or an electronic system. Method 400 is not limited by the particular type of apparatus or software element performing the method. The various actions in method 400 may be performed in the order presented, or may be performed in a different order. Further, in some embodiments, some actions listed in FIG. 4 are omitted from method 400.

Method 400 is shown beginning with block 410 in which a static branch prediction is performed. In some embodiments, the static branch prediction may be performed based on the direction of a displacement field in a branch instruction. For example, referring now back to FIG. 2, static predictor 220 may predict a branch based on the contents of displacement field 206. Further, a static predictor may perform static prediction on other static information, such as the type of opcode. At 420, if a previous branch prediction was incorrect, then the static branch prediction is overridden with a dynamic branch prediction at 430. If at 420, previous branch predictions have not been incorrect, then the static prediction is used as the predicted branch.

The dynamic prediction at 430 may be derived from state information stored for a particular branch instruction. For example, a branch prediction buffer may be maintained with state bits for a number of branch instructions. Referring now back to FIG. 3, table 300 may include state information for one or more branch instructions, and the prediction may be made based on the state. Further, in some embodiments, the state information may be updated based on whether the prediction was correct or not, and also based on whether the correct or incorrect prediction was made by a static predictor or a dynamic predictor.

FIG. 5 shows a system diagram in accordance with various embodiments of the present invention. FIG. 5 shows system 500 including processor 510, memory 520, receiver 530, and antennas 540. Processor 510 may be a processor that includes a hybrid branch predictor as described with reference to the various embodiments of the invention. Further, processor 510 may be a processor that includes a pipeline in which static and dynamic branch prediction are performed and combined in a single pipeline stage such as static branch predictor 220 and hybrid branch predictor 210 (FIG. 2).

In systems represented by FIG. 5, processor 510 is coupled to receiver 530 by conductor 512. Receiver 530 receives communications signals from antennas 540 and also communicates with processor 510 on conductor 512. In some embodiments, receiver 530 provides communications data to processor 510. Also in some embodiments, processor 510 provides control information to receiver 530 on conductor 512.

Example systems represented by FIG. 5 include cellular phones, personal digital assistants, wireless local area network interfaces, and the like. Many other systems uses for processor 510 exist. For example, processor 510 may be used in a desktop computer, a network bridge or router, or any other system without a receiver.

Receiver 530 includes amplifier 532 and demodulator (demod) 534. In operation, amplifier 532 receives communications signals from antennas 540, and provides amplified signals to demod 534 for demodulation. For ease of illustration, frequency conversion and other signal processing is not shown. Frequency conversion can be performed before or after amplifier 532 without departing from the scope of the present invention. In some embodiments, receiver 530 may be a heterodyne receiver, and in other embodiments, receiver 530 may be a direct conversion receiver. In some embodiments, receiver 530 may include multiple receivers. For example, in embodiments with multiple antennas 540, each antenna may be coupled to a corresponding receiver.

Receiver 530 may be adapted to receive and demodulate signals of various formats and at various frequencies. For example, receiver 530 may be adapted to receive time domain multiple access (TDMA) signals, code domain multiple access (CDMA) signals, global system for mobile communications (GSM) signals, orthogonal frequency division multiplexing (OFDM) signals, multiple-input-multiple-output (MIMO) signals, spatial-division multiple access (SDMA) signals, or any other type of communications signals. The present invention is not limited in this regard.

Antennas 540 may include one or more antennas. For example, antennas 540 may include a single directional antenna or an omni-directional antenna. As used herein, the term omni-directional antenna refers to any antenna having a substantially uniform pattern in at least one plane. For example, in some embodiments, antennas 540 may include a single omni-directional antenna such as a dipole antenna, or a quarter wave antenna. Also for example, in some embodiments, antennas 540 may include a single directional antenna such as a parabolic dish antenna or a Yagi antenna. In still further embodiments, antennas 540 include multiple physical antennas. For example, in some embodiments, multiple antennas are utilized to multiple-input-multiple-output (MIMO) processing or spatial-division multiple access (SDMA) processing.

Memory 520 represents an article that includes a machine readable medium. For example, memory 520 represents any one or more of the following: a hard disk, a floppy disk, random access memory (RAM), read only memory (ROM), flash memory, CDROM, or any other type of article that includes a medium readable by processor 510. Memory 520 can store instructions for performing the execution of the various method embodiments of the present invention. In operation, processor 510 reads instructions and data from memory 520 and performs actions in response thereto. For example, processor 510 may access instructions from memory 520 and communicate with receiver 530 using conductor 512. Receiver 530 may receive data from processor 510 and provide it to other circuits within receiver 530. Receiver 530 may also receive data from various circuits within receiver 530 and provide it to processor 510. For example, demod 534 may receive control data from processor 510 and may also provide data to processor 510.

Although processor 510 and receiver 530 are shown separate in FIG. 5, embodiments exist that combine the circuitry of processor 510 and receiver 530 in a single integrated circuit. Furthermore, receiver 530 can be any type of integrated circuit capable of processing communications signals. For example, receiver 530 can be an analog integrated circuit, a digital signal processor, a mixed-mode integrated circuit, or the like.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

1. A method comprising:
performing a static branch prediction for a branch; and
overriding the static branch prediction with a dynamic branch prediction when the static branch prediction has previously been incorrect;
wherein the static branch prediction and dynamic branch prediction are performed in a single pipeline stage.

2. The method of claim 1 wherein the static branch prediction comprises predicting taken or not taken based on a direction of the branch.

3. The method of claim 2 wherein predicting taken or not taken comprises predicting based on a displacement field of a branch instruction.

4. The method of claim 1 wherein the static branch prediction comprises:
determining the direction of the branch; and
if the direction of the branch is backward, then predict taken.

5. The method of claim 1 wherein the dynamic branch prediction is performed by a dynamic branch predictor having fewer than 16 entries.

6. The method of claim 1 further comprising:
overriding the static branch prediction with a dynamic branch prediction when the dynamic branch prediction has previously been incorrect.

7. The method of claim 1 further comprising updating the dynamic branch prediction when the static branch prediction is incorrect.

8. A processor comprising:
a static branch predictor to statically predict whether a branch is taken or not taken based on a direction of the branch; and
a dynamic branch predictor to conditionally override the static branch predictor.

9. The processor of claim 8 wherein the static branch predictor includes a circuit to predict the branch will be taken when the direction of the branch is backward.

10. The processor of claim 8 wherein the static branch predictor includes a circuit to predict the branch will be taken when the direction of the branch is forward.

11. The processor of claim 8 wherein the dynamic branch predictor includes a plurality of entries to hold branch prediction information for branches having had incorrect static predictions.

12. The processor of claim 11 further comprising a branch execution unit to determine the correctness of the branch prediction, and to conditionally update at least one of the plurality of entries in the dynamic branch predictor.

13. The processor of claim 8 wherein the static branch predictor and the dynamic branch predictor are coupled to operate in a single pipeline stage.

14. A processor comprising:
a static branch predictor to statically predict whether a branch is taken or not taken in one pipeline stage; and
a dynamic predictor to conditionally override the static branch predictor in the one pipeline stage.

15. The processor of claim 14 wherein the static branch predictor includes a circuit to predict whether the branch is taken based on a displacement field in a branch instruction.

16. The processor of claim 14 wherein the static branch predictor includes a circuit to predict the branch will be taken when the direction of the branch is backward.

17. The processor of claim 14 wherein the static branch predictor includes a circuit to predict the branch will be taken when the direction of the branch is forward.

18. The processor of claim 14 wherein the dynamic branch predictor is configured to provide a branch prediction only when previous static predictions have been incorrect.

19. The processor of claim 14 wherein the dynamic branch predictor includes a table for entries corresponding to previously incorrect static branch predictions.

20. The processor of claim 14 further comprising a branch execution unit to determine the correctness of the branch prediction, and to conditionally update the dynamic branch predictor.

21. An electronic system comprising:
first and second antennas;
an amplifier to amplify communications signals received by the first antenna; and
a processor coupled to the amplifier, the processor including a static branch predictor to statically predict whether a branch is taken or not taken based on a direction of the branch, and a dynamic branch predictor to conditionally override the static branch predictor.

22. The electronic system of claim 21 wherein the static branch predictor includes a circuit to predict the branch will be taken when the direction of the branch is backward.

23. The electronic system of claim 21 wherein the dynamic branch predictor includes a plurality of entries to hold branch prediction information for branches having had incorrect static predictions.

24. The electronic system of claim 23 wherein the processor further comprises a branch execution unit to determine the correctness of the branch prediction, and to conditionally update at least one of the plurality of entries in the dynamic branch predictor.

25. The electronic system of claim 21 wherein the static branch predictor and the dynamic branch predictor are coupled to operate in a single pipeline stage.
